(19) United States
(12) Patent Application Publication
(10) Pub. No.: US 2009/0323525 A1
(43) Pub. Date: Dec. 31, 2009

(54) Priority aware policer and method of priority aware policing

(76) Inventors: Charles Chen, Fremont, CA (US); Abhimanyu Das, Santa Clara, CA (US)

Correspondence Address: DOWELL & DOWELL P.C., 103 Oronoco St., Suite 220, Alexandria, VA, 22314, US

(21) Appl. No.: 12/216,019

(22) Filed: Jun. 27, 2008

(51) Int. Cl. H04L 12/24

(52) U.S. Cl. 370/230

(57) ABSTRACT

For each packet for a subscriber, a policer or method: compares the number of bytes available to the subscriber to the size of the packet; if the size is less than or equal to the number of bytes, passes the packet; if the size is larger than the number of bytes available and a priority of the packet is a first priority, processes the packet as non-conforming; if the size is larger than the number of bytes available and the priority is a second priority, and if allowing the packet to be passed will result in a deficit not exceeding a predetermined deficit value, passes the packet; and if the size is larger than the number of bytes available and the priority is the second priority, and if allowing the packet to be passed will result in a deficit exceeding the predetermined deficit value, processes the packet as non-conforming.

### FIELD OF THE INVENTION

The present invention relates to a policer and a method for policing subscribers' packets in a network.

### BACKGROUND

Quality of Service (QoS) is the ability of a network to provide better or special service to a set of customers and/or applications to the detriment of other users and/or applications. QoS is becoming increasingly important as a variety application types, such as data, voice and video, are being delivered over Internet. Where network capacity is limited, for example in broadband access networks or cellular communications networks, QoS guarantees are important. This is especially true for real-time streaming multimedia applications, for example voice over IP and IP-TV, since these often require fixed bit rate and are delay sensitive.

Traffic control is the term given to an entire packet queuing subsystem in a network or network device. In most cases, traffic control consists of several distinct operations: classifying; scheduling; shaping; and policing.

Classifying is a mechanism for identifying packets and placing them in individual flows or classes. A classifier is an entity that selects packets based on the content of packet headers according to defined rules. A multi-field (MF) classifier selects packets based on the content of some arbitrary number of header fields, typically some combination of source address, destination address, DS field, protocol ID, source port and destination port.

Scheduling is a decision-making process that decides the ordering in which packets waiting in one or multiple queues are transmitted out whenever the transmission is available. A simplest form of scheduling is a round-robin scheduler which serves each non-empty queue in a round-robin fashion. Scheduling is normally associated with traffic shaping as described next.

Shaping is a process by which packets are delayed and transmitted to produce an even and predictable flow rate. Traffic shaping can provide a mechanism to control the burstiness of traffic being sent into a network and the rate at which the traffic is being sent (rate limiting). For this reason, traffic shaping schemes are commonly implemented at the network edges to control traffic entering the network. This control can be accomplished in many ways and for many reasons. Traffic shaping can be achieved by either delaying packets by storing them in a queue, or TCP (Transmission Control Protocol) window shaping, or some combination of both. Traffic shaping is also commonly used in the direction from the network to a subscriber device or an edge device to ensure that traffic sent to the subscriber device at any one time will not exceed the capacity of the subscriber device or the edge device.

Policing is a mechanism for limiting the number of packets or bytes in a stream matching a particular classification. In other words, policing is a process of marking or discarding packets, for example by a dropper, within a traffic stream in accordance with the state of a corresponding meter enforcing a traffic profile. A policer is a device that performs policing. Traffic policing is monitoring network traffic for conformity with a traffic contract and if required, dropping traffic to enforce compliance with that contract. Traffic not conforming with a traffic contract may be tagged or marked as non-compliant, dropped, or forwarded as-is depending on circumstances. Traffic policing is commonly used in the direction from a subscriber or an edge device to the network to ensure that traffic sent to the network at any one time will not exceed the permitted capacity from the subscriber or the edge device, and this capacity is normally derived from a service level agreement (SLA) between the subscriber and the network operator.

Policing has the ability to mark those packets that exceed a rate limit. A well-known and widely deployed two rate three color marker is described in RFC 2698, “A Two Rate Three Color Marker”, September 1999.

Traffic policing was typically used in ATM (Asynchronous Transfer Mode) technology, where there was only one type of traffic associated with a virtual circuit. In other words, each virtual circuit carried the same priority traffic.

Presently, there are several applications that require the control of bandwidth or traffic rate for aggregate traffic with different types of priority (e.g. real-time or non real-time). Voice, video or data are common types of priority traffic. Eight types of priority are commonly supported over the Internet. Traffic priority from the same subscriber or device is determined through a traffic classification process. Traffic classification is usually done as soon as possible and preferably before entering the service provider's network. Once it has been classified, the priority information is carried in the packet header. There are generally two ways to carry the priority information over the Internet. For layer 2 Ethernet frames, a priority tag can be added to the frame to carry such information as defined in IEEE 802.1Q-2005 IEEE Standard for Local and Metropolitan Area Networks-Virtual Bridged Local Area Networks-Revision. For IPv4 or IPv6 packets, such information is defined and carried in the packet header in accordance with RFC 2474, “Definition of the Differentiated Services Field (DS Field) in the IPv4 and IPv6 Headers”, December 1998.

Broadband access networks sometimes use traffic control to provide QoS. To gain access to the Internet, each subscriber subscribes to the service offered by the service provider, based on the SLA. Among other policy terms and conditions, the SLA contains the QoS requirements for bandwidth, which is referred to as a traffic profile. The traffic profile includes committed information rate (CIR), peek information rate (PIR), and burst size (BS). Particularly in the Ethernet Passive Optical Networks (EPON), the traffic profile is used for the purpose of bandwidth allocation among subscribers in the upstream direction or the downstream direction of the EPON system. EPON is described in Ethernet Passive Optical Networks (EPON) Standards, IEEE 802.3-2005, IEEE Standard for Information technology-Telecommunications and information exchange between systems-Local and metropolitan area networks—Specific requirements Part 3: Carrier Sense Multiple Access with Collision Detection (CSMA/CD) Access Method and Physical Layer Specifications. The objective of the bandwidth allocation is to ensure that subscribers will gain fair access to the available bandwidth based on their respective traffic profiles. However, to enforce the bandwidth traffic profile, it is sometimes necessary to provide finer granularity of bandwidth or rate control using traffic shaping or traffic policing.

When traffic policing is applied to a single traffic flow such as video or voice or data, it is a simple and effective mechanism since it does not necessarily require any packet buffering. However, a problem arises when the same mechanism is applied to an aggregate flow of video, voice and data. In this case, the preference is to send a higher priority packet rather than a lower priority packet when there is a shortage of available bandwidth. However, a problem referred to as the priority inversion can occur since the traditional policing process does not have a way to differentiate different types of priority traffic within a traffic flow. This problem will be best described using an example illustrated in FIG. 1, where it shows the packet input process to traditional policing and the associated output process. For simplicity, we only describe two priority traffic cases: low priority traffic (such as data) and high priority traffic (such as video or voice). As illustrated in FIG. 1, a high priority traffic packet with 200 bytes in length arrives at the policer at time t₁. Since there is only 100 bytes available, indicated by T(t₁), the packet will be dropped. A low priority packet with 100 bytes in length later arrives at t₂, and will be sent to the output since there are enough bytes available, indicated by T(t₂).

Generally speaking, if a policer is applied for the rate control of two or more priority streams, each priority stream may get a share of the output rate in proportion to its input rate. For instance, if a 50 Mbps data stream and a 50 Mbps video stream are sent to the policer configured to regulate the rate at 50 Mbps. On average, 25 Mbps (50%) of each traffic stream will pass through the policer, and the rest will be dropped. The output process of the policer is regulated and dictated by the input process. More aggressive low priority input, i.e. an input that sends more traffic or traffic at a higher rate, is able to consume more bandwidth than less aggressive high priority input. In other words, the high priority traffic may be penalized at the benefit of the low priority traffic. Unfortunately, this is not the desired behaviour for rate control subject to multiple priority traffic.

Priority inversion is currently resolved using traffic shaping. However, this approach introduces a significant cost to the system due to the number of priority queues and packet memory requirement. If there is not enough packet memory to temporarily store high priority traffic, traffic shaping fails to achieve the desired behaviour. In addition, the total number of queues that are required in a system is in proportion to the number of subscribers or shapers. As a result, its implementation could be prohibited or extremely expensive in a broadband access network where each subscriber requires a shaper and the total number of subscribers is in hundreds and thousands. In summary, while traffic shaping can be implemented for inbound traffic, it is expensive and unwieldy to implement. For example, for 256 customers, enough memory for over 2000 virtual queues would be required.

An alternative is therefore sought after to reduce the complexity and cost of building an effective rate control system for the aggregated traffic flow having different priorities.

### SUMMARY OF THE INVENTION

Aspects of the present invention provide a policer and a method for providing priority aware traffic policing. These enable traffic policing to give preference to high priority traffic over low priority traffic. Some high priority traffic such as video and voice is delay sensitive, and can not be re-retransmitted if lost through the network. On the other hand, low priority such as data can tolerate a certain level of packet loss since lost packets could be re-transmitted at the source.

Throughout this specification, reference is made to “packets for the subscriber”. This means incoming packets for the subscriber and/or outgoing packets for the subscriber. Thus, in some embodiments, the packets are incoming packets for the subscriber and in other embodiments the packets are outgoing packets for the subscriber. In still other embodiments, both incoming and outgoing packets for the subscriber are included.

In accordance with one aspect of the present invention, there is provided a policer for policing subscribers' packets within a network, the policer comprising: an input for receiving packets to be policed the policer; a tracker for tracking a number of bytes available to each subscriber by: a) incrementing the number of bytes available to the subscriber as a function of time subject to a maximum number of bytes; and b) decreasing the number of bytes available to the subscriber by a size of each packet for the subscriber passed by the policer; a comparer that, for each packet for a subscriber to be policed by the policer: i) compares the number of bytes available to the subscriber to the size of the packet; ii) if the size of the packet is less than or equal to the number of bytes available to the subscriber, passes the packet; iii) if the size of the packet is larger than the number of bytes available to the subscriber and a priority of the packet is a first priority, processes the packet as non-conforming; iv) if the size of the packet is larger than the number of bytes available to the subscriber and the priority of the packet is a second priority, and if allowing the packet to be passed will result in a deficit in the number of bytes available to the subscriber that will not exceed a predetermined deficit value, passes the packet; and v) if the size of the packet is larger than the number of bytes available to the subscriber and the priority of the packet is the second priority, and if allowing the packet to be passed will result in a deficit in the number of bytes available to the subscriber that will exceed the predetermined deficit value, processes the packet as non-conforming; and an output for outputting at least the packets passed by the policer.

In accordance with a second aspect of the present invention, there is provided a method for policing subscribers' packets within a network, the method comprising, for each packet for a subscriber: receiving the packet; determining a priority of the packet; comparing a number of bytes available to the subscriber to a size of the packet; if the size of the packet is less than or equal to the number of bytes available to the subscriber, passing the packet; if the size of the packet is larger than the number of bytes available to the subscriber and the priority of the packet is a first priority, processing the packet as non-conforming; and if the size of the packet is larger than the number of bytes available to the subscriber and the priority of the packet is a second priority, and if allowing the packet to be passed will result in a deficit in the number of bytes available to the subscriber that will not exceed a predetermined deficit value, passing the packet; if the size of the packet is larger than the number of bytes available to the subscriber and the priority of the packet is the second priority, and if allowing the packet to be passed will result in a deficit in the number of bytes available to the subscriber that will exceed the predetermined deficit value, processing the packet as non-conforming.

In accordance with a third aspect of the present invention, there is provided a computer readable medium having computer readable instructions stored thereon, that when executed cause a computer to implement a method for policing subscribers' packets within a network, the method comprising, for each packet for a subscriber: receiving the packet; determining a priority of the packet; comparing a number of bytes available to the subscriber to a size of the packet; if the size of the packet is less than or equal to the number of bytes available to the subscriber, passing the packet; if the size of the packet is larger than the number of bytes available to the subscriber and the priority of the packet is a first priority, processing the packet as non-conforming; and if the size of the packet is larger than the number of bytes available to the subscriber and the priority of the packet is a second priority, and if allowing the packet to be passed will result in a deficit in the number of bytes available to the subscriber that will not exceed a predetermined deficit value, passing the packet; if the size of the packet is larger than the number of bytes available to the subscriber and the priority of the packet is the second priority, and if allowing the packet to be passed will result in a deficit in the number of bytes available to the subscriber that will exceed the predetermined deficit value, processing the packet as non-conforming.

Other aspects and features of the present invention will become apparent, to those ordinarily skilled in the art, upon review of the following description of the specific embodiments of the invention.

### BRIEF DESCRIPTION OF THE DRAWINGS

Examples of embodiments of the invention will now be described in greater detail with reference to the accompanying drawings, in which:

FIG. 1 is a graphical representation of traditional traffic policing applied to packets of different priority;

FIG. 2 is a block diagram of a policer in accordance with one embodiment of the present invention;

FIG. 3 is a block diagram of a policer in accordance with one embodiment of the present invention;

FIG. 4 is a block diagram of a policer in accordance with one embodiment of the present invention;

FIG. 5 is a flowchart of a method of policing in accordance with one embodiment of the present invention;

FIG. 5A is a flowchart of a method of policing in accordance with one embodiment of the present invention;

FIG. 6 is a flowchart of a method of policing in accordance with one embodiment of the present invention;

FIG. 7 is a graphical representation of priority aware policing applied to packets of different priority;

FIG. 8 is a block diagram of a policer in accordance with one embodiment of the present invention;

FIG. 9 is a graphical representation of a method of priority aware policing; and

FIG. 10 is a block diagram of network illustrating one embodiment of the present invention.

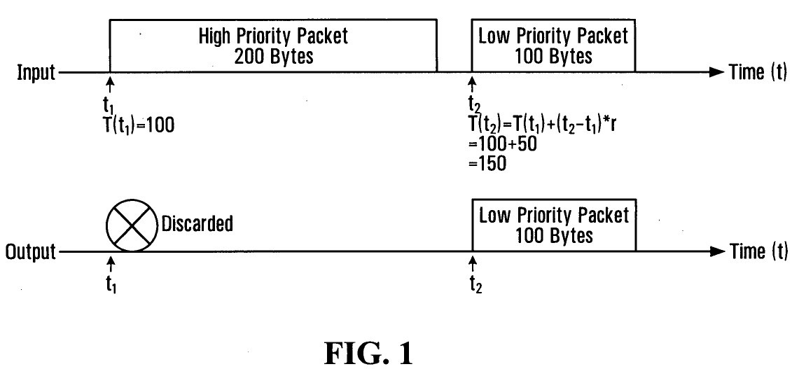

### DETAILED DESCRIPTION OF THE PREFERRED EMBODIMENTS

Embodiments of this invention provide priority aware traffic policing.

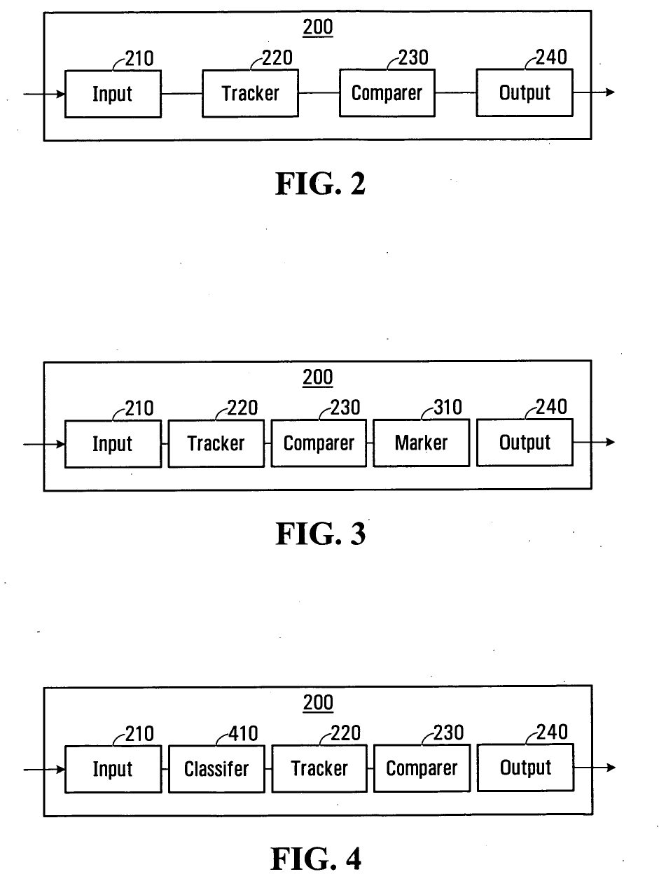

Referring to FIG. 2, one embodiment of the invention is a priority aware policer 200. The policer 200 is for policing packets for a subscriber within a network and comprises an input 210, a tracker 220, a comparer 230 and an output 240.

The input 210 is for receiving packets for the subscriber to be policed the policer 200. In some embodiments the input 210 determines the priority of each packet received. In some embodiments the policer 200 is located at the ingress of the network and the packets for the subscriber received at the input 210 are received from a subscriber's device or an edge device. In some embodiments, the policer is located at the egress to the network and the packets for the subscriber are received from the network to be sent to the subscriber's device or an edge device.

The tracker 220 is for tracking a number of bytes available to each subscriber. The tracker 220 increments the number of bytes available to the subscriber as a function of time subject to a maximum number of bytes. For example, the number of bytes might be incremented at a rate that may be a variable rate or a fixed rate. In some embodiments, the rate for increasing the bytes available to a subscriber and the maximum number of bytes available to the subscriber are set in an SLA between the subscriber and a network provider. The tracker 220 also decreases the number of bytes available to the subscriber by a size of each packet for the subscriber passed by the policer. In the policer 200, the tracker 220 can decrease the number of bytes available to a negative value (i.e. a deficit situation) depending on a priority of the packet.

For each packet for a subscriber to be policed by the policer, the comparer 230 compares the number of bytes available to the subscriber to the size of the packet. If the size of the packet is less than or equal to the number of bytes available to the subscriber, the comparer 230 passes the packet. Otherwise, the comparer 230 performs one of the following steps depending on the priority of the packet.

If the size of the packet is larger than the number of bytes available to the subscriber and the priority of the packet, is a first priority, the comparer 230 processes the packet as non-conforming. In some embodiments, this first priority is a low priority. Low priority packets, can for example be packets that are not sensitive to delays, such as data packets. Processing as non-conforming is implementation specific and may, for example, include one or more of dropping the packet or preventing the packet from being passed, or marking the packet as non-conforming. In some embodiments, packets marked as non-conforming are policed again at a later time. In some embodiments the packets marked as non-conforming are discarded by the network at a later time. In some situations, a packet has a traffic priority and a drop priority. A non-conforming packet can be marked as a high drop priority so that it could be discarded later in the network due to traffic congestion.

If the size of the packet is larger than the number of bytes available to the subscriber and the priority of the packet is a second priority, and if allowing the packet to be passed will result in a deficit in the number of bytes available to the subscriber that will not exceed a predetermined deficit value, the comparer 230 passes the packet. In some embodiments this second priority is a high priority. High priority packets, for example, can be but are not limited to packets sensitive to delay, such as video, voice, Voice over IP packets and IPTV packets. The predetermined deficit value for the second priority can be set out in an SLA or determined by a service provider. It can be any value and in some embodiments is equal to the largest burst expected from the various traffic types. In some embodiments, the predetermined deficit value is equal to the maximum number of bytes available for the respective subscriber.

If the size of the packet is larger than the number of bytes available to the subscriber and the priority of the packet is the second priority, and if allowing the packet to be passed will result in a deficit in the number of bytes available to the subscriber that will exceed the predetermined deficit value, the comparer 230 processes the packet as non-conforming.

The output 240 is for outputting at least the packets passed by the policer. If the policer 200 is located at the ingress to the network, the output outputs the packets to the network. If the policer is located at the egress to the network, the output, outputs the packets to the subscriber's device.

In some embodiments, there are more than two priorities. The priorities in excess of two are referred to here as a plurality of further priorities. For example, as mentioned above, the Internet has eight priorities. In some embodiments of the present invention, multiple priorities are each assigned a different deficit value. The comparer 230 is further configured to, for each packet of the subscriber to be policed, perform the following steps. If the size of the packet is larger than the number of bytes available to the subscriber and the priority of the packet is one of a plurality of further priorities, and if allowing the packet to be passed will result in a deficit in the number of bytes available to the subscriber that will not exceed a respective predetermined deficit value associated with the one of the plurality of further priorities, the comparer 230 passes the packet. If the size of the packet is larger than the number of bytes available to the subscriber and the priority of the packet is one of the plurality of further priorities, and if allowing the packet to be passed will result in a deficit in the number of bytes available to the subscriber that will exceed the respective predetermined deficit value associated with the one of the plurality of further priorities, the comparer 230 processes the packet as non-conforming.

FIG. 3 is a block diagram of an embodiment of the policer 200 that further comprises a marker 310 for marking non-conforming packets for policing at a later time. The marker 310 is depicted in FIG. 3 between the comparer 210 and the output 230. However, the marker 310 can be located at any location in the policer 200 and in some embodiments, may be external to the policer 200. In some embodiments, the marker 310 assigns a packet drop precedence or packet drop priority to the non-conforming packets. This packet drop precedence or priority may be used by the network to determine whether a packet will be entered into a memory or whether a packet will be dropped.

Referring to FIG. 4, in some embodiments, the policer 200 further comprises a classifier 410 for determining the priority of each packet and adding a priority value to the respective packet indicating the priority for the respective packet. In some embodiments, the priority of the packet is identified in the header of the packet, such as the Differentiated Services field in the IP header, or the 802.1p field in the VLAN header.

The embodiments comprising the memory 310 and the classifier 410 are not mutually exclusive of each other. It is feasible to have a priority aware policer 200 with both the classifier 410 and the memory 310.

The priority aware policers of the invention can be implemented using hardware, software, firmware or combinations thereof. Policers, according to the invention, can be implemented at any point in a network and in any network device. For example, they can be located at a computer, a switch, a router, a modem, a residential gateway, or any traffic engineering component, but are not limited to these implementations.

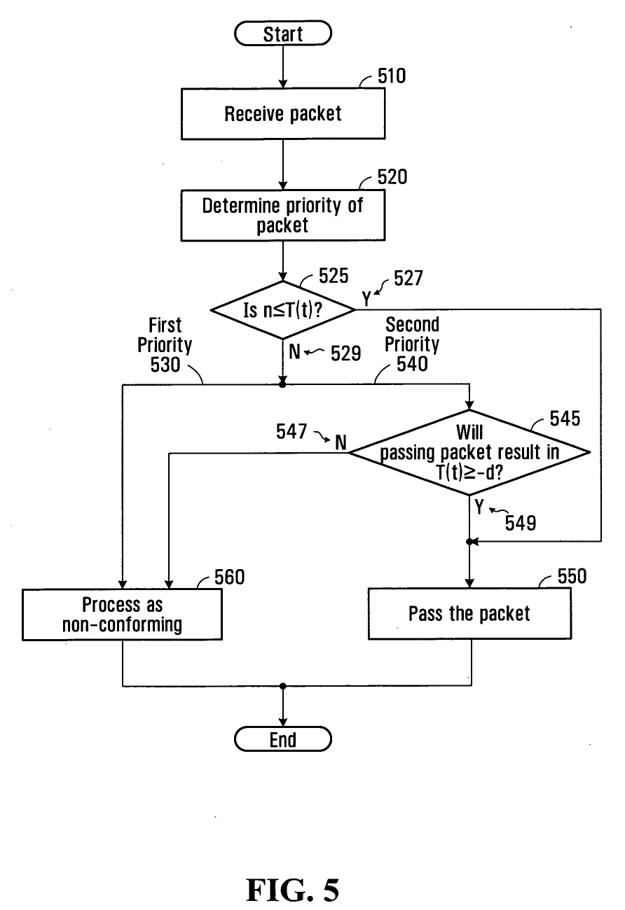

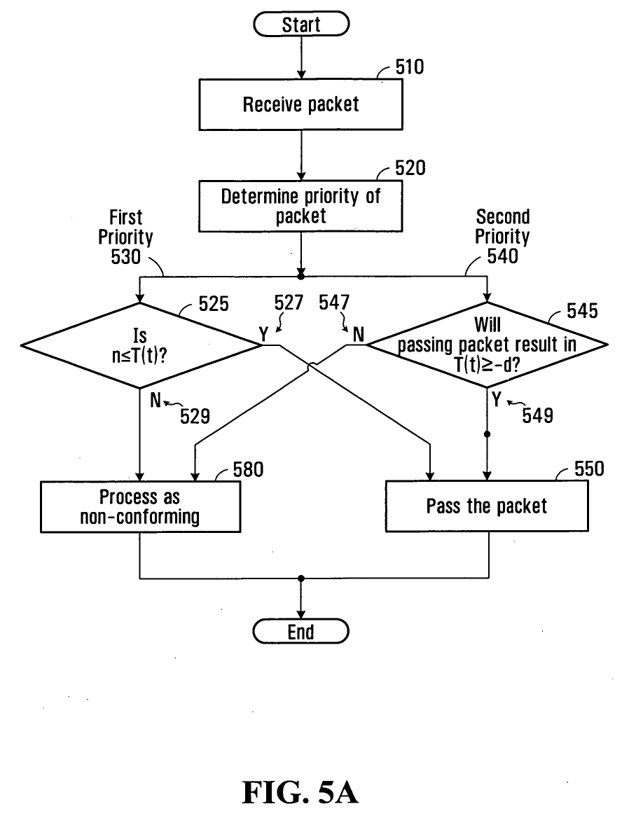

Referring now to FIG. 5, a method for policing subscribers' packets within a network, will now be described. The method will be described as applied to each packet for a subscriber. It is to be understood that the same method can be applied to any packet for any subscriber.

For each packet for a subscriber, the method comprises at step 510, receiving the packet. In the policer 200 described above, this is done at the input 210.

At step 520 a priority of the packet is determined. In some methods, the priority will be either a first priority or a second priority. The determination of priority may be done by the input 210 or in some embodiments by the classifier 410.

At step 525, the method continues with comparing a number of bytes available to the subscriber to a size of the packet. For ease of reference, the number of bytes available is referred to as T(t) and the size of the packet is referred to as n. If the size of the packet, n, is less than or equal to the number of bytes available T(t) to the subscriber (Yes response 527 to step 525), the packet is passed at step 550. In some embodiments, passing the packet 550 is comprised of outputting the packet from the output 240, described with reference to FIG. 2.

If the size of the packet, n, is larger than the number of bytes available T(t) to the subscriber (No response 529 to step 525) and the priority of the packet is a first priority (Option 530 of No response 529), the packet is processed as non-conforming at step 560. Processing as non-conforming 560 can include dropping the packet or marking the packet as non-conforming.

If the size of the packet, n, is larger than the number of bytes available T(t) to the subscriber (No response 529 to step 525) and the priority is a second priority (Option 540 to No response 529), the method proceeds to Step 545. Step 545 is a determination of whether or not passing the packet will exceed a predetermined deficit value, referred to as d. If allowing the packet to be passed will result in a deficit in the number of bytes available T(t) to the subscriber that will not exceed the predetermined deficit value d (yes response 549 to step 545), the packet is passed at step 550.

If allowing the packet having the second priority 540 to be passed will result in a deficit in the number of bytes available T(t) to the subscriber that will exceed the predetermined deficit value d (No response 547 of step 545), the packet is processed as non-conforming at step 560.

The steps of the methods described herein are not necessarily performed in the order described. For example, in some embodiments, step 525 takes place only for the first priority packets. This embodiment is shown in FIG. 5A, which is the same as FIG. 5, with the exception of step 525, which is only performed for first priority packets, i.e. option 530. In this embodiment if the packet is second priority 540, the method only determines whether or not T(t)−n is greater than or equal to −d.

In some embodiments, the method further comprises incrementing the number of bytes available to the subscriber as a function of time subject to a maximum number of bytes. In still further embodiments, the method also comprises decreasing the number of bytes available by the size of any packet passed. The number of bytes available can be decreased as a further function of time.

In some embodiments, the method further comprises adding a priority value to the packet indicating the priority of the packet.

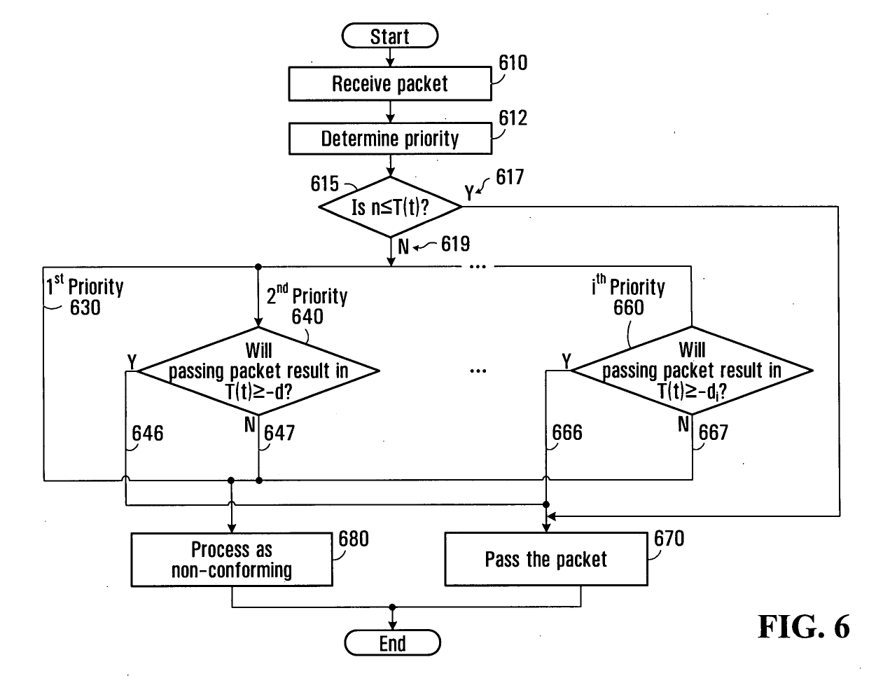

In a further embodiment, illustrated in FIG. 6, the method is applied to situations with more than two priorities. As with the method described with reference to FIG. 5, this embodiment will be described as it applies to a packet for a subscriber. However, the method equally applies to any packet from any subscriber. Step 610 in this embodiment is receiving the packet and is the same as step 510, described with reference to FIG. 5. Step 612 is determining the priority of the packet. In this embodiment, the priority of the packet is a first priority, a second priority, or any of a plurality of priorities, for example up to an i^{th} priority.

At step 615, there is a determination of whether or not the size of the packet, n, is less than or equal to the number of bytes available T(t) to the subscriber. If the answer is Yes 617, the packet is passed at step 670. If the answer is No 619, the method proceeds according to the priority of the packet.

As with the previously described method, if the priority of the packet is the first priority 630, and the size of the packet is greater than T(t), then the packet is processed as non-conforming at step 680. The processing as non-conforming 680 in this method is the same as the processing as non-conforming 560 described with reference to FIG. 5.

Step 640, with a Yes response 646 and a No response 647, mirrors step 545 described with reference to FIG. 5 for packets of the second priority, where the question of whether T(t)≧−d is asked. If the response is Yes 646, the packet is passed 670 and if the response is No 647, the packet is processed as non-conforming 680.

If the size of the packet, n, is larger than the number of bytes available T(t) to the subscriber and the priority of the packet is one of the plurality of further priorities, 660, and if allowing the packet to be passed will result in a deficit in the number of bytes available to the subscriber that will not exceed a respective predetermined deficit value dᵢ associated with the one of the plurality of further priorities (Yes response 666 of step and 660, respectively), the packet is passed at step 670.

If the size of the packet n is larger than the number of bytes available T(t) to the subscriber and the priority of the packet is one of the plurality of further priorities, and if allowing the packet to be passed will result in a deficit in the number of bytes available to the subscriber that will exceed the respective predetermined deficit value dᵢ associated with the one of the plurality of further priorities (No response 667 of steps 660 respectively), the packet is processed as non-conforming at step 680.

In some embodiments of the invention, determining the priority of the packet comprises classifying the priority of the packet as one of the first priority, the second priority and the plurality of further priorities.

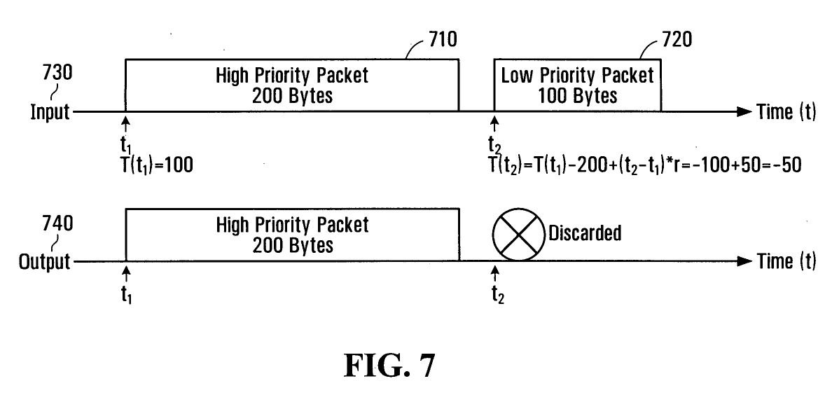

An example of the results of this method is depicted graphically in FIG. 7. A high priority packet 710 with a size of 200 bytes arrives at an input 730 of a policer at time t₁ and a low priority packet 720 with a size of 100 bytes arrives at the input 730 at time t₂. The policer outputs at a rate r. In this example, (t₂−t₁)*r=50. Because the high priority packet 710 is able to move the total bytes available T(t) to a deficit state (T(t₂)=T(t₁)−200+(t₂−t₁)*r=−100+50=−50) and thus be passed by the output 740 of the policer, priority inversion is avoided. The low priority packet 720 is dropped because T(t₂) is in a deficit or negative state upon its arrival.

In a further embodiment of the invention, a computer readable medium has computer readable instructions stored thereon, that when executed cause a computer to implement any of the methods described herein.

Traffic control is sometimes described using the concept of tokens. Policing or shaping implementations need to calculate the number of bytes or packets that have passed and at what rate. Using the concept of tokens, each packet or byte (depending on the implementation), corresponds to a token, and the policing or shaping implementation will only transmit or pass the packet if it has sufficient tokens available. A metaphorical container in which an implementation keeps its tokens is a bucket. In short, the bucket represents both the number of tokens which can be used instantaneously (the size of the bucket), and the rate at which the tokens are replenished (how fast the bucket gets refilled).

One type of bucket analogy is referred to as a token bucket. The token bucket can be conceptually explained as follows. A token is added to the bucket every 1/r seconds. The bucket can hold at the most b tokens. If a token arrives when the bucket is full, it is discarded. If a packet arrives and its size of n tokens is less than the available tokens, the packet is sent to the network and n tokens are removed from the bucket. If its size is greater than the available tokens, the packet is dropped or marked and no tokens are removed from the bucket. The method allows bursts of up to b bytes, but over the long run the output of conformant packets is limited to the constant rate, r. Implementers of this method on platforms lacking the clock resolution necessary to add a single token to the bucket every 1/r seconds may use an alternative formulation. Given the ability to update the token bucket every s milliseconds, the number of tokens to add every s milliseconds=(r*s)/500. Thus, at any time, the largest burst a source can send into the network is roughly proportional to the size of the bucket. A token bucket permits burstiness, but bounds it by the size of the bucket. The token bucket method is used for traffic policing.

The token bucket scheme described above can be formulated as follows. The number of tokens available at a time of t can be defined as T(t). The function T(t) dynamically changes as tokens are added at a rate of r constantly, and packets consume tokens upon their arrivals. The number of tokens that are accumulated between time t₂ and t₁ where (t₂>t₁), is (t₂−t₁)*r.

When a packet with size of n bytes arrives at a time t, it will be transmitted if the T(t) is greater or equal to n, while n tokens will be deducted from the T(t). If T(t) is less than n, the packet will be dropped or marked.

The policer and method of the present invention leverage the simplicity of policing without queuing for a rate control while providing traffic priority differentiation, using for example, a new token bucket.

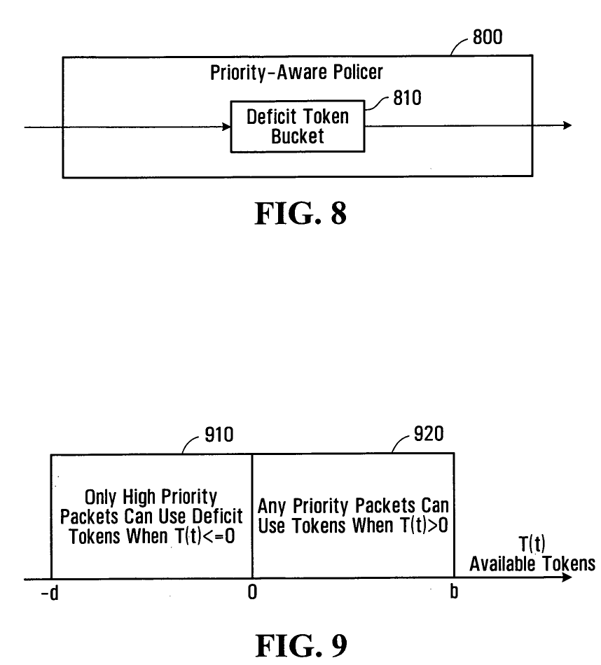

Referring to FIG. 8, this new type of token bucket may be referred to as a deficit token bucket 810, and can be part of a priority aware policer 800. The deficit token bucket 810 allows high priority packets to borrow tokens, i.e. become deficit whenever necessary, as a means to provide differential treatment on how tokens are applied to incoming packets. FIG. 9 illustrates an example of this concept. There are two priority traffic streams in this example: low priority and high priority. In addition to two parameters of b and r, a third parameter d (deficit) is introduced to the token bucket. The parameter d, represents a predetermined deficit value. As a result, there are two regions, a region where T(t) is greater than zero and less than b 920 and a region where T(t) is less than or equal to zero and greater than −d 910, in which tokens can be applied to incoming packets.

When T(t) is greater than zero and less than b 920, any incoming packet can be applied against the tokens available if the packet is less than or equal to T(t). If n is greater than T(t), deficit tokens can be borrowed and applied to high priority packets up to the value of d. Over the long run, in this embodiment, the output of conformant packets is still limited to the constant rate, r. This is because the process of credit or token accumulation remains the same at the rate of r.

An embodiment of a priority aware deficit token bucket method where there are two priorities can also be described as follows:

1. Configure the deficit token bucket with three parameters (b, d, and r);
2. Denote T(t) as the number of available tokens available at the time t;
3. Increment T(t) at the rate of r, and stop incrementing when T(t) reaches the value b;
4. For a low priority incoming packet of size n, transmit the packet if and only if T(t)−n is greater than or equal to 0. Otherwise, discard the packet or mark the packet as non-conforming;
5. For high priority incoming packet of size n, transmit the packet if and only if T(t)−n is greater than or equal to −d. Otherwise, discard the packet or mark the packet as non-conforming; and
6. If the packet is transmitted, deduct T(t) by the value of n.

As described above, the deficit token bucket method can generally be extended to support more than two priorities. This is achieved by introducing an additional deficit value for each type of priority traffic. To support m number of priority traffic, we can introduce deficit values (d₀, d₁, . . . , dm-₁), where d₀ is by default equal to zero. In this scenario, priority 0 is the lowest priority traffic which can consume tokens as long as T(t)>d₀. The priority j (0<j<m) is higher priority traffic and can borrow up to dⱼ deficit tokens. The priority m−1 is the highest priority traffic and can borrow up to dₘ₋₁ deficit tokens. An embodiment of the method for policing more than two priorities can be described as follows:

1. Configure the deficit token bucket with the following parameters (b, d₀, d₁, . . . , dₘ₋₁, and r), where d₀<=d₁<= . . . <=dₘ₋₁;
2. Denote T(t) as the number of available tokens available at the time t;
3. Increment T(t) at the rate of r, and stop incrementing when T(t) reaches the value of b;
4. For the priority j (0<=j<=m−1) incoming packet of size n, transmit the packet if and only if T(t)−n is greater than or equal to −dⱼ. Otherwise discard the packet or mark the packet as non-conforming; and
5. If the packet is transmitted, deduct T(t) by the value of n.

The deficit token bucket is simple to implement and can avoid the priority inversion problem. The applications of this invention can be broadly extended to any network element to achieve a rate control where the priority based queuing and shaping is not feasible or would be costly.

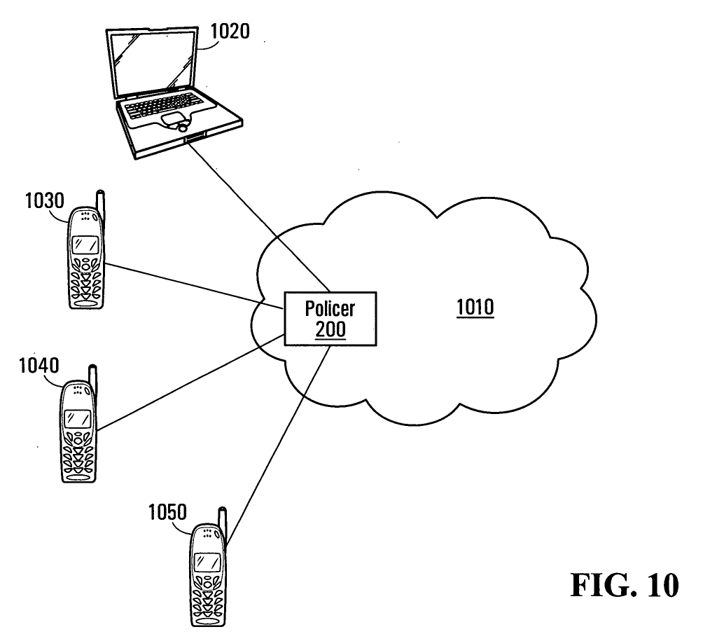

The policer of the present invention is used in a network, and in some embodiments at the ingress to such a network. FIG. 10 shows an embodiment of the policer 200 at the ingress to a network 1010. The policer 200 polices packets sent from subscribers' devices 1020, 1030, 1040 and 1050 to the network 1010. For illustrative purposes only, three mobile telephones 1030, 1040, 1050 and one computer 1020 are shown as the subscribers' devices. However, the subscribers' devices can be any devices configured to send packets over the network 1010. Non-limiting examples of the network 1010 comprise the Internet, the Ethernet, a broadband access network, a cellular communications network, and a passive optical network.

What has been described is merely illustrative of the application of the principles of the invention. Other arrangements and methods can be implemented by those skilled in the art without departing from the spirit and scope of the present invention.

1. A policer for policing subscribers' packets within a network, the policer comprising:
an input for receiving packets to be policed the policer;
a tracker for tracking a number of bytes available to each subscriber by:
a) incrementing the number of bytes available to the subscriber as a function of time subject to a maximum number of bytes; and
b) decreasing the number of bytes available to the subscriber by a size of each packet for the subscriber passed by the policer;
a comparer that, for each packet for a subscriber to be policed by the policer:
i) compares the number of bytes available to the subscriber to the size of the packet;
ii) if the size of the packet is less than or equal to the number of bytes available to the subscriber, passes the packet;
iii) if the size of the packet is larger than the number of bytes available to the subscriber and a priority of the packet is a first priority, processes the packet as non-conforming;
iv) if the size of the packet is larger than the number of bytes available to the subscriber and the priority of the packet is a second priority, and if allowing the packet to be passed will result in a deficit in the number of bytes available to the subscriber that will not exceed a predetermined deficit value, passes the packet; and
v) if the size of the packet is larger than the number of bytes available to the subscriber and the priority of the packet is the second priority, and if allowing the packet to be passed will result in a deficit in the number of bytes available to the subscriber that will exceed the predetermined deficit value, processes the packet as non-conforming; and
an output for outputting at least the packets passed by the policer.

2. The policer of claim 1, wherein the comparer is further configured to, for each packet of the subscriber to be policed:
if the size of the packet is larger than the number of bytes available to the subscriber and the priority of the packet is one of a plurality of further priorities, and if allowing the packet to be passed will result in a deficit in the number of bytes available to the subscriber that will not exceed a respective predetermined deficit value associated with the one of the plurality of further priorities, pass the packet; and
if the size of the packet is larger than the number of bytes available to the subscriber and the priority of the packet is one of the plurality of further priorities, and if allowing the packet to be passed will result in a deficit in the number of bytes available to the subscriber that will exceed the respective predetermined deficit value associated with the one of the plurality of further priorities, process the packet as non-conforming.

3. The policer of claim 2, wherein the plurality of further priorities comprises at least six priority types.

4. The policer of claim 1, wherein for at least one packet, processing as non-conforming comprises marking the packet as non-conforming.

5. The policer of claim 1, wherein for at least one packet, processing as non-conforming comprises preventing the packet from being passed.

6. The policer of claim 4, further comprising a marker for marking non-conforming packets for policing at a later time.

7. The policer of claim 1, wherein the network is any one of the Internet, the Ethernet, a broadband access network, a cellular communications network, and a passive optical network and a Local Area Network (LAN).

8. The policer of claim 1, wherein the policer is located at an ingress to the network and the packets are being sent from subscriber devices.

9. The policer of claim 1, further comprising a classifier for determining the priority of each packet and adding a priority value to the respective packet indicating the priority for the respective packet.

10. The policer of claim 1, wherein each packet comprises any one of data, voice, video and combinations thereof.

11. A method for policing subscribers' packets within a network, the method comprising, for each packet for a subscriber:
receiving the packet;
determining a priority of the packet;
comparing a number of bytes available to the subscriber to a size of the packet;
if the size of the packet is less than or equal to the number of bytes available to the subscriber, passing the packet;
if the size of the packet is larger than the number of bytes available to the subscriber and the priority of the packet is a first priority, processing the packet as non-conforming; and
if the size of the packet is larger than the number of bytes available to the subscriber and the priority of the packet is a second priority, and if allowing the packet to be passed will result in a deficit in the number of bytes available to the subscriber that will not exceed a predetermined deficit value, passing the packet;
if the size of the packet is larger than the number of bytes available to the subscriber and the priority of the packet is the second priority, and if allowing the packet to be passed will result in a deficit in the number of bytes available to the subscriber that will exceed the predetermined deficit value, processing the packet as non-conforming.

12. The methods of claim 11, further comprising incrementing the number of bytes available to the subscriber as a function of time subject to a maximum number of bytes.

13. The method of claim 12, further comprising, if the packet is passed, decreasing the number of bytes available by the size of any packet.

14. The method of claim 13, wherein the number of bytes available is decreased as a further function of time.

15. The method of claim 11, further comprising:
if the size of the packet is larger than the number of bytes available to the subscriber and the priority of the packet is one of a plurality of further priorities, and if allowing the packet to be passed will result in a deficit in the number of bytes available to the subscriber that will not exceed a respective predetermined deficit value associated with the one of the plurality of further priorities, passing the packet; and
if the size of the packet is larger than the number of bytes available to the subscriber and the priority of the packet is one of the plurality of further priorities, and if allowing the packet to be passed will result in a deficit in the number of bytes available to the subscriber that will exceed the respective predetermined deficit value associated with the one of the plurality of further priorities, processing the packet as non-conforming.

16. The method of claim 11, wherein determining the priority of the packet comprises classifying the priority of the packet as one of the first priority, the second priority and the plurality of further priorities.

17. The method of claim 11, wherein for at least one packet, processing as non-conforming comprises preventing the packet from being passed.

18. The method of claim 11, wherein for at least one packet, processing as non-conforming comprises marking the packet as non-conforming.

19. The method of claim 18, further comprising adding a priority value to the packet indicating the priority of the packet.

20. A computer readable medium having computer readable instructions stored thereon, that when executed cause a computer to implement a method for policing subscribers' packets within a network, the method comprising, for each packet for a subscriber:
receiving the packet;
determining a priority of the packet;
comparing a number of bytes available to the subscriber to a size of the packet;
if the size of the packet is less than or equal to the number of bytes available to the subscriber, passing the packet;
if the size of the packet is larger than the number of bytes available to the subscriber and the priority of the packet is a first priority, processing the packet as non-conforming; and
if the size of the packet is larger than the number of bytes available to the subscriber and the priority of the packet is a second priority, and if allowing the packet to be passed will result in a deficit in the number of bytes available to the subscriber that will not exceed a predetermined deficit value, passing the packet;
if the size of the packet is larger than the number of bytes available to the subscriber and the priority of the packet is the second priority, and if allowing the packet to be passed will result in a deficit in the number of bytes available to the subscriber that will exceed the predetermined deficit value, processing the packet as non-conforming.
